(19) United States
(12) Patent Application Publication
(10) Pub. No.: US 2006/0005045 A1
(43) Pub. Date: Jan. 5, 2006

(54) Control system for security apparatus and control method using same

(75) Inventor: Takafumi Nakase, Osaka (JP)

Correspondence Address: GEORGE A. LOUD, 625 SLATERS LANE, FOURTH FLOOR, ALEXANDRIA, VA, 22314, US

(73) Assignee: FUNAI ELECTRIC CO., LTD., Osaka (JP)

(21) Appl. No.: 11/150,096

(22) Filed: Jun. 13, 2005

(30) Foreign Application Priority Data
Jun. 18, 2004 (JP) 2004-181619

(51) Int. Cl. G06F 11/30

(52) U.S. Cl. 713/190

(57) ABSTRACT

A security apparatus and method automatically set and cancel a crime-prevention monitoring mode, while preventing unauthorized control. The security apparatus includes a portable terminal, carried by a person allowed to enter and exit a predetermined area, for transmitting address data identifying the person, an address data memory 34 for registering the address data, a receiver 10 for receiving the address data at the entrance to the predetermined area, a setting circuit 2 for selectively setting the crime-prevention monitoring mode, and a camera 11 for obtaining image data of the person passing through the entrance. A controller starts the camera when reception of the address data is started, and stops the photographing when the reception of the address data is ended. A comparison circuit compares image data stored in an image data memory with image data obtained when the address data is received and cancels the crime-prevention monitoring mode when a match occurs.

### BACKGROUND OF THE INVENTION

1. Field of the Invention

The present invention relates to control systems for security apparatus designed to prevent the invasion of an unauthorized person into a predetermined area, and to control methods using same. More particularly, the invention is directed to a control system for a security apparatus which automatically sets or cancels a crime-prevention monitoring mode for the apparatus, according to the entry or exit of an authorized object or person allowed to enter or exit the predetermined area.

2. Description of the Related Art

Conventionally, a control system for a security apparatus has been proposed which automatically judges whether or not a resident has gone out and sets an absence mode (crime-prevention monitoring state) based on the determination, as disclosed in, for example, JP-A-5-101284. This known system is adapted to give an alarm only during the residents' absence, but not when the resident opens a window at home. Further, the system is designed to automatically switch settings between the presence and absence modes. Such automatic switching between the presence and absence modes has an advantage over manual switching in that it can eliminate the possibility that the resident forgets the setting of the mode to go out.

More specifically, this control system for a security apparatus includes a monitoring camera disposed at an entrance for monitoring the entry or exit of persons, a numerical memory for previously registering the number of persons present in a house, identification means for performing image processing of image information obtained from the monitoring camera and for identifying the person's entry or exit, updating means for updating the number of persons stored in the numerical memory based on the person's entry or exit identified by the identification means, and absence-mode setting means for automatically setting the absence mode (crime-prevention monitoring state) when the number of persons in the house determined by the updating means is zero. That is, this system is operable to obtain the number of persons who have gone out, as data from the image information provided by the monitoring camera. Then, the system automatically sets the security apparatus in the absence mode when a difference between a value of the obtained data and that of initialized numeric data is zero. On the other hand, the system also cancels the absence mode (crime-prevention monitoring state) by employing the following method. For example, the method involves 1) entering a password of a resident or party concerned by pressing a push-button switch of a home controller provided in the system, thereby canceling the absence mode, 2) registering fingerprints of several residents and parties concerned by a fingerprint detector provided in the home controller, and verifying the fingerprints (ID identification) so as to cancel the absence mode, or 3) allowing a resident to insert a specific key into a knob of a door, thereby canceling the mode.

In the prior art system, however, the entry or exit of persons is identified based on change in the image information obtained at the entrance. For this reason, for example, in cases where a lot of customers frequently pass an entrance, it is very difficult to identify whether the customers have surely entered the entrance or not. This gives rise to a risk that the number of persons who are supposed to be present in the house may be wrongly updated even when a customer drops by a house at the entrance and then leaves. In contrast, there is another risk that, in a case where a resident stands at the entrance in an attempt to go out, but then stays inside the house without going out, the resident may be wrongly judged to have gone out. Thus, the default number of persons, or the number of persons who have gone out is wrongly determined. Even if the number of persons present in the house is actually zero, the apparatus judges someone to be at home, thus failing to switch to the absence mode. Therefore, the known security apparatus suffers from a disadvantage that it cannot switch automatically from the presence mode to the absence mode when nobody is in the house, thus failing to perform its inherent function.

### SUMMARY OF THE INVENTION

Accordingly, it is an object of the invention to provide a control system for a security apparatus that surely and automatically sets or cancels a crime-prevention monitoring mode in the security apparatus, and a control method using same.

To solve the foregoing problems, according to one aspect of the invention, there is provided a control system for a security apparatus which comprises a portable terminal carried by a person of interest allowed to enter and exit a predetermined area, for transmitting address data for specifying the person, a transmissible area of the terminal being set in a narrow range, address data storage means for previously storing and registering the address data therein, reception means for receiving the address data when the person carrying the portable terminal enters and/or exits an entrance located in the predetermined area, a receivable area of the reception means being set in a narrow range around the entrance, and setting means (for example, a setting circuit 2) for selectively setting the security apparatus for monitoring crime prevention in the predetermined area, in a crime-prevention monitoring mode. The control system further comprises image data obtaining means (for example, a camera 11) for obtaining image data by photographing the person passing through the entrance, and control means (which includes, for example, a processing circuit 35, and a control-signal generating circuit 36) for causing the image data obtaining means to start photographing when the reception of the address data is started by the address data reception means, and for causing the image data obtaining means to finish photographing when the reception of the address data is ended. In particular, the control system further comprises storage means (which includes, for example, the processing circuit 35, and an image data memory 37) for storing therein first image data of the person obtained by the image data obtaining means under control of the control means while the crime-prevention monitoring mode is cancelled, in relation to the address data of the person, comparison means (for example, a comparison circuit 39) for comparing the first image data corresponding to the address data and stored in the storage means, with second image data of the person obtained by the image data obtaining means when the address data of the person is received while the security apparatus is set in the crime-prevention monitoring mode, and processing means (which includes, for example, the processing circuit 35, and the setting circuit 2) for causing the setting means to cancel the crime-prevention monitoring mode of the security apparatus when a match occurs as a result of comparison between the image data performed by the comparison means.

According to another aspect of the invention, there is provided a control system for a security apparatus which comprises a portable terminal carried by a person of interest allowed to enter and exit a predetermined area, for transmitting address data for specifying the person, address data storage means for previously storing and registering the address data therein, address data reception means for receiving the address data when the person carrying the portable terminal enters and/or exits an entrance located in the predetermined area, and setting means (for example, the setting circuit 2) for selectively setting the security apparatus for monitoring crime prevention in the predetermined area, in a crime-prevention monitoring mode. The control system further comprises image data obtaining means (for example, the camera 11) for obtaining image data by photographing the person passing through the entrance when the address data is received by the address data reception means. In particular, the control system further comprises storage means (for example, the image data memory 37) for storing therein first image data of the person obtained by the image data obtaining means when the address data of the person is received while the crime-prevention monitoring mode is canceled, in relation to the address data, comparison means (for example, the comparison circuit 39) for comparing the first image data corresponding to the address data and stored in the storage means with second image data of the person obtained by the image data obtaining means when the address data of the person is received while the security apparatus is set in the crime-prevention monitoring mode, and processing means (which includes, for example, the processing circuit 35, and the setting circuit 2) for causing the setting means to cancel the crime-prevention monitoring mode of the security apparatus when a match occurs as a result of comparison between the image data performed by the comparison means.

According to a further aspect of the invention, there is provided a method for controlling a security apparatus which comprises the steps of storing and registering address data which is given to a person of interest allowed to enter and exit a predetermined area, in an address data memory (for example, step S1), and receiving the address data when the person carrying a portable terminal for transmitting the address data to an area in a narrow range exits an entrance located in the predetermined area (for example, step S2). The method further comprises the steps of photographing the person going out by operating a camera after confirming the registration of the address data in the address data memory (for example, steps S3 and S4), and finishing the photographing when the reception of the address data is ended to store first image data obtained by the photographing with the camera, in an image data memory (for example, step S5), when the address data is received while a security apparatus for monitoring crime prevention in the predetermined area is in a cancel state of a crime-prevention monitoring mode. In particular, the method further comprises the steps of judging whether all the persons of interest have gone out or not (for example, step S6), controlling the security apparatus to switch from the cancel state of the crime-prevention monitoring mode to a setting state thereof based on the judgment (for example, step S7), obtaining second image data of the person with the camera when the address data of the person is received near the entrance while the security apparatus is set in the crime-prevention monitoring mode (for example, steps S8, S9, and S10), comparing the thus-obtained second image data of the person with the first image data corresponding to the address data and stored in the image data memory (for example, step S11), and canceling the crime-prevention monitoring mode of the security apparatus when a match occurs as a result of comparison between the image data (for example, step S12).

According to a still further aspect of the invention, there is provided a method for controlling a security apparatus which comprises the steps of storing and registering address data which is given to a person of interest allowed to enter and exit a predetermined area, in an address data memory (for example, step S1), and receiving the address data when the person carrying a portable terminal for transmitting the address data exits an entrance located in the predetermined area (for example, step S2). The method further comprises the steps of, when the address data is received while the security apparatus for monitoring crime prevention in the predetermined area is in a cancel state of a crime-prevention monitoring mode, obtaining first image data by photographing the person going out by operating a camera after confirming the registration of the address data in the address data memory (for example, steps S3 and S4), and storing the first image data obtained in an image data memory (for example, step S5). In particular, the method further comprises the steps of judging whether all the persons of interest have gone out or not (for example, step S6), controlling the security apparatus to switch from the cancel state of the crime-prevention monitoring mode to a setting state thereof based on the judgment (for example, step S7), obtaining second image data of the person with the camera when the address data of the person is received while the security apparatus is set in the crime-prevention monitoring mode (for example, steps 8, 9, and 10), comparing the thus-obtained second image data of the person with the first image data corresponding to the address data and stored in the image data memory (for example, step S11), and canceling the crime-prevention monitoring mode of the security apparatus when a match occurs as a result of comparison between the image data (for example, step S12).

With this arrangement, the control system of the invention performs the following operation. That is, in the control system for a security apparatus according to one aspect of the invention, the person of interest allowed to enter and exit the predetermined area is specified by the address data, which is stored and registered in the address data storage means. In addition, the portable terminal is provided for transmitting the address data, and carried by the person. The address data is received by the reception means when the person carrying the portable terminal enters and/or exits the entrance located in the predetermined area, wherein the receivable range of the reception means is set in a narrow range around the entrance. In the control system, the image data obtaining means starts obtaining of the image data by photographing the person passing the entrance when the reception of the address data is started, and then completes obtaining of the image data by finishing photographing of the person when the reception state of the address data is ended. More specifically, in this control system, when the address data is received and the first image data of the person or object is obtained by the image data obtaining means while the security apparatus for monitoring crime prevention of the predetermined area is not set in the crime-prevention monitoring mode by the setting means, the thus-obtained first image data is stored in the storage means in relation to the address data. When the address data is rendered unreceivable after storing the first image data in the storage means, it is confirmed that the person of interest has left the entrance. Thereafter, in the control system, when the address data is received and the second image data of the person is obtained by the image data obtaining means while the security apparatus is set in the crime-prevention monitoring mode, the thus-obtained second image data is compared with the first image data corresponding to the address data and stored in the storage means by the comparison means. If a match occurs as a result of comparison between the image data performed by the comparison means, then the control system causes the setting means to cancel the crime-prevention monitoring mode of the security apparatus. Accordingly, the control system for a security apparatus according to one aspect of the invention has the following effects.

Now, the first effect of the system will be described hereinafter. In the control system, the person of interest, who is a resident, is previously registered by the corresponding address data, and if image data of the person is not obtained at a time when the address data is received, then the person is judged to have just gone out. On the other hand, if the image data of the person is already obtained at a time when the control system receives the address data, then the person is judged to return home. Accordingly, the invention can provide a control system for a security apparatus which can judge correctly whether the person of interest has gone out or come home, and which can appropriately set the security apparatus in the crime-prevention monitoring mode based on the judgment.

The second effect of the system will be described below. In the control system, if the portable terminal is owned by an unauthorized person other than the person of interest, who is not specified by the address data, and the unauthorized person intends to illegally enter the entrance carrying the terminal, image data of the unauthorized person obtained by the image data obtaining means is not matched with that of the person of interest as a result of comparison. This does not cancel the crime-prevention monitoring mode of the security apparatus. Accordingly, the invention can provide a control system for a security apparatus that can surely prevent unauthorized use of the address data.

The third effect of the system will be described below. In the control system, the image data obtaining means starts photographing in synchronization with the start of reception of the address data performed by the reception means, and finishes the photographing in synchronization with the end of reception of the address data. Then, the image data obtained is attached with the corresponding address data, so that the photographing can be carried out surely and automatically. In addition, the control system judges the person to have left the entrance when the address data is rendered unreceivable after storing the first image data in the storage means, and then performs a control operation on the assumption that the person has gone out. Accordingly, the invention can provide a control system for a security apparatus that not only permits precise control of the start and end of obtaining the image data, but also can surely judge the person to have gone out.

In the control system for a security apparatus according to another aspect of the invention, the person of interest allowed to enter and exit the predetermined area is specified by the address data, which is stored and registered in the address data storage means. In addition, the portable terminal is provided for transmitting the address data, and carried by the person. The address data is received by the reception means when the person carrying the terminal enters and/or exits the entrance located in the predetermined area. In reception of the address data, the image data obtaining means photographs the person passing the entrance to thereby obtain the image data. More specifically, in this control system, when the address data is received and the first image data of the person is obtained by the image data obtaining means while the security apparatus for monitoring crime prevention of the predetermined area is not set in the crime-prevention monitoring mode by the setting means, the thus-obtained first image data is stored in the storage means in relation to the address data. On the other hand, in the control system, when the address data is received and the second image data of the person is obtained by the image data obtaining means while the security apparatus is set in the crime-prevention monitoring mode, the thus-obtained second image data is compared with the first image data corresponding to the address data and stored in the storage means by the comparison means. If a match occurs as a result of comparison between the image data performed by the comparison means, then the control system causes the setting means to cancel the crime-prevention monitoring mode of the security apparatus. Accordingly, the control system for a security apparatus according to another aspect of the invention has the following effects.

Now, the first effect of the system will be described hereinafter. In the control system, the person of interest, who is a resident, is previously registered by the corresponding address data, and if image data of the person is not obtained at a time when the address data is received, then the person is judged to have just gone out. On the other hand, if the image data of the person is already obtained at a time when the control system receives the address data, then the person is judged to return home. Accordingly, the invention can provide a control system for a security apparatus that can judge correctly whether the person of interest has gone out or come home, and which can appropriately set the security apparatus in the crime-prevention monitoring mode based on the judgment.

The second effect of the system will be described below. In the control system, if the portable terminal is owned by an unauthorized person other than the person of interest, who is not specified by the address data, and the unauthorized person intends to illegally enter the entrance carrying the terminal, image data of the unauthorized person obtained by the image data obtaining means is not matched with that of the person of interest as a result of comparison. This does not cancel the crime-prevention monitoring mode of the security apparatus. Accordingly, the invention can provide a control system for a security apparatus that can surely prevent unauthorized use of the address data.

In the method for controlling a security apparatus according to the further aspect of the invention, the address data which is given to the person of interest allowed to enter and exit the predetermined area is stored in the address data memory, and the address data is received when the person carrying the portable terminal for transmitting the address data to an area in a narrow range exits the entrance located in the predetermined area. Furthermore, when the address data is received while the security apparatus for monitoring crime prevention in the predetermined area is in the cancel state of the crime-prevention monitoring mode, the person going out is photographed by operating the camera after confirming the registration of the address data in the address data memory. Thereafter, the first image data obtained by the photographing is stored in the image data memory. When the address data is rendered unreceivable after storing the first image data in the memory, it is confirmed that the person of interest has left the entrance. Then, it is determined whether all the persons of interest have gone out or not, and the security apparatus is controlled to switch from the cancel state of the crime-prevention monitoring mode to a setting state thereof based on the determination. On the other hand, the second image data of the person is obtained with the camera when the address data of the person is received while the security apparatus is set in the crime-prevention monitoring mode. The thus-obtained second image data of the person is compared with the first image data corresponding to the address data and stored in the image data memory. If the match occurs as a result of comparison between the image data, then the crime-prevention monitoring mode of the security apparatus is canceled. Accordingly, the method for controlling a security apparatus according to the further aspect of the invention has the following effects.

Now, the first effect of the method will be described hereinafter. In the control method, the person of interest, who is a resident, is previously registered by the corresponding address data, and if image data of the person is not obtained at a time when the address data is received, then the person is judged to have just gone out. On the other hand, if the image data of the person is already obtained at a time when the address data is received, then the person is judged to return home. Accordingly, the invention can provide a method for controlling a security apparatus that can judge correctly whether the person of interest has gone out or come home, and which can appropriately set the security apparatus in the crime-prevention monitoring mode based on the judgment.

The second effect of the method will be described below. In the control method, if the portable terminal is owned by an unauthorized person other than the person of interest, who is not specified by the address data, and the unauthorized person intends to illegally enter the entrance carrying the terminal, image data of the unauthorized person obtained by the image data obtaining means is not matched with that of the person of interest as a result of comparison. This does not cancel the crime-prevention monitoring mode of the security apparatus. Accordingly, the invention can provide a method for controlling a security apparatus that can surely prevent unauthorized use of the address data.

The third effect of the method will be described below. In the control method, the image data obtaining means starts photographing in synchronization with the start of reception of the address data performed by the reception means, and finishes the photographing in synchronization with the end of reception of the address data. Then, the image data obtained is attached with the corresponding address data, so that the photographing can be carried out surely and automatically. Additionally, in the control method, the person is judged to have left the entrance when the address data is rendered unreceivable after storing the first image data in the storage means, and then the control operation is performed on the assumption that the person has gone out. Accordingly, the invention can provide a method for controlling a security apparatus that not only permits precise control of the start and end of obtaining the image data, but also can surely judge the person to have gone out.

In the method for controlling a security apparatus according to the still further aspect of the invention, the address data which is given to the person of interest allowed to enter and exit the predetermined area is stored and registered in the address data memory, and the address data is received when the person carrying the portable terminal carried by the person for transmitting the address data exits the entrance located in the predetermined area. Furthermore, when the address data is received while a security apparatus for monitoring crime prevention in the predetermined area is in a cancel state of the crime-prevention monitoring mode, the person going out is photographed with the camera after confirming the registration of the address data in the address data memory. The first image data obtained by the photographing is stored in the image data memory, and it is determined whether all the persons of interest have gone out or not. Based on the determination, the security apparatus is controlled to switch from the cancel state of the crime-prevention monitoring mode to the setting state thereof. On the other hand, the second image data of the person is obtained with the camera when the address data of the person is received while the security apparatus is set in the crime-prevention monitoring mode. The thus-obtained second image data of the person is compared with the first image data corresponding to the address data and stored in the image data memory. If the match occurs as a result of comparison between the image data, then the crime-prevention monitoring mode of the security apparatus is canceled. Accordingly, the method for controlling a security apparatus according to the still further aspect of the invention has the following effects.

Now, the first effect of the method will be described hereinafter. In the control method, the person of interest, who is a resident, is previously registered by the corresponding address data, and if image data of the person is not obtained at a time when the address data is received, then the person is judged to have just gone out. On the other hand, if the image data of the person is already obtained at a time when the control system receives the address data, then the person is judged to return home. Accordingly, the invention can provide a method for controlling a security apparatus which can judge correctly whether the person of interest has gone out or come home, and which can appropriately set the security apparatus in the crime-prevention monitoring mode based on the judgment.

The second effect of the method will be described below. In the control method, if the portable terminal is owned by an unauthorized person other than the person of interest, who is not specified by the address data, and the unauthorized person intends to illegally enter the entrance carrying the terminal, image data of the unauthorized person obtained by the image data obtaining means is not matched with that of the person of interest as a result of comparison. This does not cancel the crime-prevention monitoring mode of the security apparatus. Accordingly, the invention can provide a method for controlling a security apparatus that can surely prevent unauthorized use of the address data.

### BRIEF DESCRIPTION OF THE DRAWINGS

FIG. 1 is a block diagram showing a security control system according to one preferred embodiment of the invention;

FIG. 2 is a block diagram showing a controller of FIG. 1; and

FIG. 3 is a flowchart showing an operation of the system according to the preferred embodiment.

### DESCRIPTION OF THE PREFERRED EMBODIMENTS

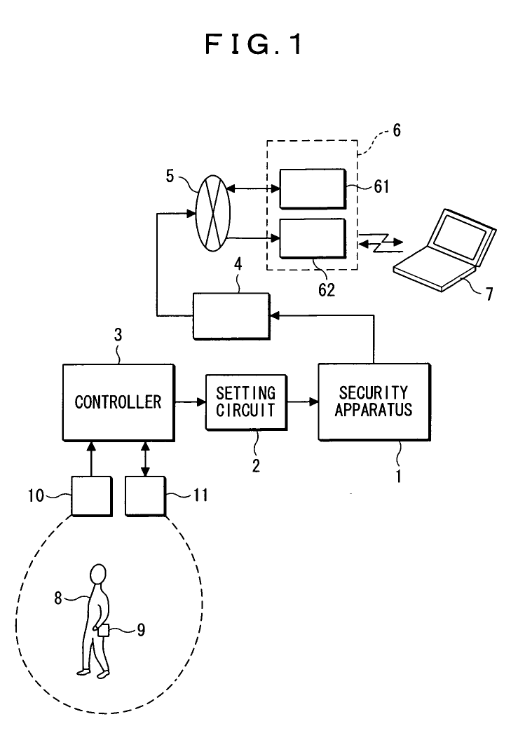

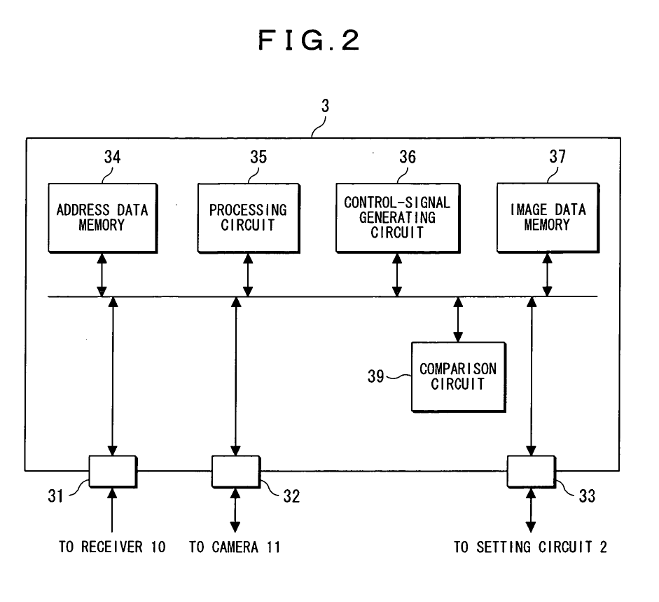

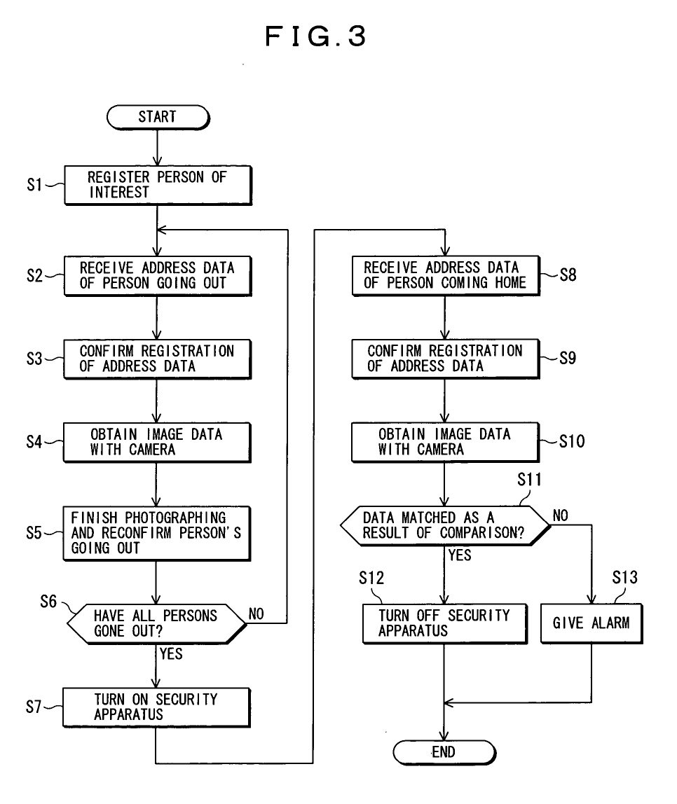

One preferred embodiment according to the invention will be hereinafter described in detail with reference to FIGS. 1, 2, and 3. FIG. 1 shows a block diagram of a control system for a security apparatus in a case where the embodiment of the invention is applied to a normal housing, and FIG. 2 a block diagram of a controller in the system shown in FIG. 1. FIG. 3 is a flowchart showing an operation of the system in the embodiment.

Referring to FIG. 1, a security apparatus 1 includes detectors disposed on parts of the housing, such as an entrance, a shutter, or a window, which may be invaded by an unauthorized person from the outside. The security apparatus 1 is turned on by a setting circuit 2 into a crime-prevention monitoring mode, and turned off to cancel the mode. The setting circuit 2 is connected at its input to a controller 3, and operated by outputs from the controller 3. The security apparatus 1 is connected at its output to a gateway 4 provided in the housing. The gateway 4 is connected at its output to a distribution system 6 via a network 5. If an abnormal event is detected when the security apparatus 1 is in the crime-prevention monitoring mode, then information on the abnormal event is transmitted to a terminal device 7 via the gateway 4, the network 5, and the distribution system 6.

A person or object of interest 8 is a resident in the housing. A portable terminal 9 is to transmit address data for specifying the person 8. The person 8 carries the portable terminal 9 at least when going out.

At an entrance serving as a doorway of the housing, is disposed a receiver 10 for receiving the address data transmitted from the portable terminal 9. Further, a camera 11 is provided for photographing persons passing through the entrance to obtain image data thereof. The outputs from the receiver 10 are fed to the controller 3. When the address data is sent from the receiver 10, the controller 3 operates the camera 11 to photograph the person 8 carrying the portable terminal 9. Data communication between the portable terminal 9 and the receiver 10 employs a Bluetooth system of short-range radio communication, and thus a communicable area is limited to the surroundings of the entrance.

The details of the controller 3 are given in FIG. 2. The controller 3 includes interfaces 31, 32, and 33. The interface 31 is connected to the receiver 10, the interface 32 to the camera 11, and the interface 33 to the setting circuit 2. The controller 3 includes an address data memory 34 for storing therein the address data of the person 8, a processing circuit 35 for performing comparison processing of various kinds of data, a control-signal generating circuit 36 for generating control signals for start and stop of the operation of the camera 11, and the like, an image data memory 37 for storing therein the image data obtained by the camera 11, and a comparison circuit 39 for comparing the image data stored in the image data memory 37 with the image data obtained with the camera 11.

If address data is fed from the receiver 10 when the security apparatus 1 is set in an off state by the setting circuit 2, the processing circuit 35 verifies the fed address data against the address data stored in the address data memory 34. When a match occurs, this data is transmitted to the control-signal generating circuit 36. The control-signal generating circuit 36 sends a start signal to the camera 11 based on the matched data. That is, when the person 8 is going out, photographing with camera 11 is automatically started. This image data obtained by the photographing is stored in the image data memory 37 in relation to the address data.

The processing circuit 35 determines that the person 8 leaves the entrance to have departed from the communicable area, thus rendering the reception of the address data impossible. The processing circuit transmits data on the determination to the control-signal generating circuit 36. Then, the control-signal generating circuit 36 sends a stop signal to the camera 11 according to the determination data. It should be noted that a plurality of persons 8 are generally of interest, and all of them 8 have their address data previously stored in the address data memory 34.

The processing circuit 35 stores the image data about all the persons 8 in the image data memory 37 until all of them are gone out based on their address data stored in the address data memory 34. The processing circuit 35 judges whether all the persons 8 have gone out or not. If yes, the circuit 35 sends a control signal for setting the security apparatus 1 in the crime-prevention monitoring mode, to the setting circuit 2. In addition, as the person leaves the entrance to depart from the communicable area after the image data is stored in the image data memory 36, the reception of address data is rendered impossible, and thus it is reconfirmed that the person have gone out.

When the person 8 returns home from the outside and enters the communicable area in front of the entrance, the address data from the portable terminal 9 is received by the receiver 10. The received address data is transmitted to the controller 3. Then, the controller 3 controls the control-signal generating circuit 36 to generate the start signal for starting an operation of the camera 11. The comparison circuit 39 reads the image data obtained with the camera 11 and the image data with an address corresponding to the address data from the image data memory 37, and performs a comparison between the image data. When a match occurs as a result of comparison performed by the comparison circuit 39, the processing circuit 35 sends out the control signal to the setting circuit 2 to turn off the security apparatus 1. Simultaneously, the processing circuit 35 controls the control-signal generating circuit 36 to generate the stop signal for stopping the operation of the camera 11.

Now, an operation of the system with the above configuration of the embodiment will be explained with reference to the flowchart of FIG. 3. At a step S1, address data is given to a resident at home, who is the person of interest 8, and is stored and registered in the address data memory 34. The security apparatus 1 is set in an off state when the person 8 is present in the house. Thus, an initial state is set. The person 8 carries the portable terminal 9 for transmitting the address data every time he/she goes out. Then, at a step S2, when the person 8 exits an entrance carrying the portable terminal 9 to go out, the receiver 10 receives the address data from the terminal 9 to feed it to the controller 3. In reception of the address data, the controller 3 verifies the received address data against the address data registered in the address data memory 34 to confirm the registration of the data as shown at a step S3. If the registration is confirmed, the processing circuit 35 controls the control-signal generating circuit 36 to generate the start signal for starting the operation of the camera 11, so that the image data can be obtained with the camera 11 at a step S4. When the person 8 leaves the entrance to depart form the communicable area, the reception of the address data is terminated. The processing circuit 35 detects the termination of reception, and causes the control-signal generating circuit 36 to generate the stop signal, thereby finishing the photographing with the camera 11 as shown at a step S5. In addition, the processing circuit 35 reconfirms the person has gone out when the address data is rendered unreceivable because the person is away from the entrance to depart from the communicable area after storing the image data in the image data memory 36.

As mentioned above, a plurality of pieces of image data about a plurality of persons 8 going out in sequence are obtained with the camera 11, and then attached with respective address data to be stored in the image data memory 37. At a step S6, the processing circuit 35 verifies the received address data against the registered address data to judge whether or not the image data about all the persons are obtained and whether or not they have gone out. If the processing circuit 35 judges all the persons to have gone out based on the registered address data, the processing circuit operates the setting circuit 2 to turn on the security apparatus 1 into the crime-prevention monitoring mode at a step S7.

The security apparatus 1 set in the crime-prevention monitoring mode is operable to detect the invasion of an unauthorized person from the entrance, the shutter, the window, or the like, and to transmit information on this abnormal event to a server 61 via the gateway 4 and the network 5. Then, alarm information is transmitted from a base station 62 to the far-off terminal device 7. Via the terminal device 7, stored data in the server 61 of the distribution system 6 is retrieved to monitor the condition of the security apparatus 1.

In the crime-prevention monitoring mode set during the residents' absence, when the person 8 comes home, the address data of the person is received by the receiver 10 as shown at a step S8. The received address data is fed to the controller 3. When the address data is received, the controller 3 verifies the received address data against the address data registered in the address data memory 34 to confirm the registration of the data, as shown at a step S9. After confirmation of the registration, the processing circuit 35 controls the control-signal generating circuit 36 to generate the start signal for starting the operation of the camera 11 to obtain image data with the camera 11 at a step S10. The comparison circuit 39 compares the image data obtained with the camera 11 at the step S10, namely, the second image data, with the image data stored in the image data memory 37, having an address corresponding to the address data, namely, the first image data, as shown at a step S11. A method for comparing or verifying the photographed image with or against the stored image is disclosed in, for example, JP-A-2003-22443, JP-A-2001-283224, and JP-A-2000-341679. If a match occurs as a result of comparison performed by the comparison circuit 39, the processing circuit 35 sends a control signal for turning off the security apparatus 1 to the setting circuit 2 at a step S12. At the same time, the processing circuit 35 controls the control-signal generating circuit 36 to generate the stop signal for stopping the operation of the camera 11. Thus, the controller 3 confirms that the person 8 has retuned home, and then turns off the security apparatus 1 to cancel the crime-prevention monitoring mode. For this reason, the security apparatus 1 does not perform a crime-prevention operation which involves alarming, transmitting the information on the abnormal event, or the like, when the person 8 enters the entrance.

At the step S11, if the match between the image data is not obtained, the security apparatus 1 sounds an alarm about the invasion of the unauthorized person illegally carrying the portable terminal 9, while at the same time transmitting the information on the abnormal event to the distribution system 6 at a step S13. The image data obtained at this time is transmitted to the server 61 of the distribution system 6 via the gateway 4 and the network 5. If necessary, the image data is transmitted to the terminal device 7, and used to confirm the invasion of the unauthorized person.

At the step S9, if the received address data is not registered in the address data memory 34, someone other than the person of interest 8 is judged to visit the house during the person's absence, and thus the comparison between the image data is not performed. However, if the visitor intends to illegally enter the house, the security apparatus 1 detects the visitor's illegal invasion, and gives the alarm.

According to the above preferred embodiment of the invention, a user specifies the person of interest 8 allowed to enter and exit the predetermined area by the address data, and the address data is stored and registered in the address data memory 34. On the other hand, the person 8 enters and/or exits the entrance located in the predetermined area, carrying the portable terminal 9 for transmitting his/her own address data. When the person carrying the portable terminal enters and/or exits the entrance, the control system receives the address data by the receiver 10, and operates the camera 11 in the reception of the address data to photograph the person passing through the entrance, thereby obtaining the image data. Furthermore, when the address data is rendered unreceivable after storing the image data in the image data memory 37, the processing circuit 35 determines that the person of interest has left the entrance. More specifically, after the address data is received and the first image data of the person is obtained with the camera while the security apparatus 1 is set in a cancel state of the crime-prevention monitoring mode by the setting circuit 2, the control system stores the thus-obtained first image data in the image data memory 37 in relation to the address data. And, after the address data is received and the second image data of the person 8 is obtained with the camera 11 while the security apparatus 1 is set in the crime-prevention monitoring mode, the comparison circuit 39 in the control system reads the image data stored in the image data memory and corresponding to the address data, namely, the first image data, from the memory, and performs comparison between the image data. If a match occurs between the image data as a result of comparison performed by the comparison circuit 39, the setting circuit 2 in the control system cancels the crime-prevention monitoring mode of the security apparatus 1.

Therefore, in the control system of the invention, the person of interest 8, who is a resident, is previously registered by the corresponding address data, and if image data of the person is not obtained at a time when the address data is received, then the person is judged to have just gone out. On the other hand, if the image data of the person is already obtained at a time when the control system receives the address data, then the person is judged to be at home or return home. In the control system, if the portable terminal 9 is owned by an unauthorized person other than the person 8, who is not specified by the address data, due to the loss or theft thereof, and the unauthorized person intends to illegally enter the entrance carrying the terminal, image data of the unauthorized person obtained with the camera 11 is not matched with that of the person 8 previously stored as a result of comparison. This does not cancel the crime-prevention monitoring mode of the security apparatus, thereby enabling prevention of the invasion of the unauthorized person other than the person of interest, who illegally uses the portable terminal 9. The camera 11 starts photographing in synchronization with the start of reception of the address data performed by the receiver 10, and finishes the photographing in synchronization with the end of reception of the address data. Then, the image data obtained is attached with the corresponding address data, so that the photographing can be carried out surely and automatically. In addition, the control system confirms that the person has left the entrance when the address data is rendered unreceivable after storing the image data in the image data memory 37, and then performs the control operation on the assumption that the person 8 has gone out.

It should be noted that in the above embodiment, in photographing the person 8 going out with the camera 11, the photographing is not finished until the termination of reception of the address data is detected, but the invention is not limited thereto. For example, in another case, the processing circuit 35 may be provided with a function of determining whether the given time has elapsed since the start of the photographing, and the control-signal generating circuit 36 may send a stop signal after the given time has elapsed. Alternatively or additionally, in the earlier of the two cases, the photographing with the camera 11 may be finished.

Note that the portable terminal 9 of the above embodiment may further have another function of transmitting the address data to a card, equipment, or the like which has other functions, and thus may perform both of this another function and the original function.

Although the Bluetooth system is used as the short-range radio communications in the above embodiment, the invention is not limited thereto. For example, various other systems, such as a wireless LAN system, can be applied. Although the object of crime prevention provided by the security apparatus 1 is the house in the above embodiment, the invention is not limited thereto. The object of crime prevention can be one of various facilities including a storehouse and an office.

What is claimed is:

1. A control system for a security apparatus, comprising:
a portable terminal carried by a person of interest allowed to enter and exit a predetermined area, for transmitting address data for specifying the person, a transmissible area of the terminal being set in a narrow range;
address data storage means for previously storing and registering the address data therein;
reception means for receiving the address data when the person carrying the portable terminal enters and/or exits an entrance located in the predetermined area, an receivable area of the reception means being set in a narrow range around the entrance;
setting means for selectively setting the security apparatus for monitoring crime prevention in the predetermined area, in a crime-prevention monitoring mode;
image data obtaining means for obtaining image data by photographing the person passing through the entrance;
control means for causing the image data obtaining means to start photographing when the reception of the address data is started by the address data reception means, and for causing the image data obtaining means to finish photographing when the reception of the address data is ended;
storage means for storing therein first image data of the person obtained by the image data obtaining means when the address data of the person is received while the security apparatus is not set in the crime-prevention monitoring mode, in relation to'the address data;
comparison means for comparing said first image data corresponding to the address data and stored in the storage means with second image data of the person obtained by the image data obtaining means when the address data of the person is received while the security apparatus is set in the crime-prevention monitoring mode; and
processing means for causing the setting means to cancel the crime-prevention monitoring mode of the security apparatus when a match occurs as a result of comparison between the image data performed by the comparison means.

2. A control system for a security apparatus, comprising:
a portable terminal carried by a person of interest allowed to enter and exit a predetermined area, for transmitting address data for specifying the person;
address data storage means for previously storing and registering the address data therein;
address data reception means for receiving the address data when the person carrying the portable terminal enters and/or exits an entrance located in the predetermined area;
setting means for selectively setting the security apparatus for monitoring crime prevention in the predetermined area, in a crime-prevention monitoring mode;
image data obtaining means for obtaining image data by photographing the person passing through the entrance when the address data is received by the address data reception means;
storage means for storing therein first image data of the person obtained by the image data obtaining means when the address data of the person is received while the security apparatus is not set in the crime-prevention monitoring mode, in relation to the address data;
comparison means for comparing said first image data corresponding to the address data and stored in the storage means with second image data of the person obtained by the image data obtaining means when the address data of the person is received while the security apparatus is set in the crime-prevention monitoring mode; and
processing means for causing the setting means to cancel the crime-prevention monitoring mode of the security apparatus when a match occurs as a result of comparison between the image data performed by the comparison means.

3. A method for controlling a security apparatus, comprising the steps of:
storing and registering address data which is given to a person of interest allowed to enter and exit a predetermined area, in an address data memory;
receiving the address data when the person carrying a portable terminal for transmitting the address data to an area in a narrow range exits an entrance located in the predetermined area;
photographing the person going out by operating a camera after confirming the registration of the address data in the address data memory when the address data is received while the security apparatus for monitoring crime prevention in the predetermined area is in a cancel state of a crime-prevention monitoring mode;
finishing the photographing to store first image data obtained by the photographing with the camera, in an image data memory when the reception of the address data is ended;
judging whether all the persons of interest have gone out or not;
controlling the security apparatus to switch from the cancel state of the crime-prevention monitoring mode to a setting state thereof based on the judgment;
obtaining second image data of the person with the camera when the address data of the person is received near the entrance while the security apparatus is set in the crime-prevention monitoring mode;
comparing said second image data of the person obtained with the first image data corresponding to the address data and stored in the image data memory; and
canceling the crime-prevention monitoring mode of the security apparatus when a match occurs as a result of comparison between the image data.

4. A method for controlling a security apparatus, comprising the steps of:
storing and registering address data which is given to a person of interest allowed to enter and exit a predetermined area, in an address data memory;
receiving the address data when the person carrying a portable terminal for transmitting the address data exits an entrance located in the predetermined area;
obtaining first image data by photographing the person going out by operating a camera after confirming the registration of the address data in the address data memory when the address data is received while the security apparatus for monitoring crime prevention in the predetermined area is in a cancel state of a crime-prevention monitoring mode;
storing the first image data obtained in an image data memory;
judging whether all the persons of interest have gone out or not;
controlling the security apparatus to switch from the cancel state of the crime-prevention monitoring mode to a setting state thereof based on the judgment;
obtaining second image data of the person with the camera when the address data of the person is received while the security apparatus is set in the crime-prevention monitoring mode;
comparing said second image data of the person obtained with the first image data corresponding to the address data and stored in the image data memory; and
canceling the crime-prevention monitoring mode of the security apparatus when a match occurs as a result of comparison between the image data.
